(19) United States
(12) Patent Application Publication
(10) Pub. No.: US 2025/0026402 A1
(43) Pub. Date: Jan. 23, 2025

(54) APPARATUS FOR AND METHOD OF CONTROLLING REAR-WHEEL STEERING

(71) Applicant: HYUNDAI MOBIS CO., LTD., Seoul (KR)

(72) Inventor: Tae Hong KIM, Yongin-si (KR)

(73) Assignee: HYUNDAI MOBIS CO., LTD., Seoul (KR)

(21) Appl. No.: 18/620,196

(22) Filed: Mar. 28, 2024

(30) Foreign Application Priority Data
Jul. 20, 2023 (KR) 10-2023-0094725

(51) Int. Cl. B62D 6/00

(52) U.S. Cl. CPC B62D 6/003

(57) ABSTRACT

Proposed is an apparatus for rear-wheel steering, the apparatus including a sensor module configured to detect steering and driving information of a rear-wheel steering vehicle; and a processor configured to vary instantaneously a desired yaw rate or turning radius by further adjusting a gear ratio between front and rear wheels in response to column torque and vehicle speed detected through the sensor module, resulting in more dynamic lateral control than previously possible.

### CROSS-REFERENCE TO RELATED APPLICATION

This application claims priority from and the benefit of Korean Patent Application No. 10-2023-0094725, filed on Jul. 20, 2023, which is hereby incorporated by reference for all purposes as if set forth herein.

### BACKGROUND

### Field

Exemplary embodiments of the present disclosure relate to an apparatus for and a method of controlling rear-wheel steering.

### Discussion of the Background

Active front steering (AFS), commonly applied to vehicles, ensures front-wheel steering responsiveness and driving stability through a variable gear ratio steering system situated between a steering wheel and a steering actuator, which is configured to take input of a steering wheel angle, transmit a varied rotation angle to the AFS actuator, and variably adjust a steering gear ratio.

In addition, rear-wheel steering (RWS) ensures rear-wheel steering responsiveness and driving stability by determining a rear wheel angle based on inputs such as steering wheel angles and vehicle speeds and by controlling the rear wheel angle through the operation of the RWS actuator.

As described above, the rear-wheel steering enhances rear-wheel steering responsiveness by turning the rear wheels in the opposite direction to the front wheels, reducing turning radius during low-speed driving. Furthermore, the rear-wheel steering ensures driving stability by turning the rear wheels in the same direction as the front wheels, reducing yaw rate during high-speed driving. As described above, conventional rear-wheel steering simply assists the front-wheel steering in controlling the rear wheels to prioritize steering responsiveness during low-speed driving and prioritize driving stability during high-speed driving.

More recently, there has been the development of in-wheel motor systems, a concept that includes both front-wheel and rear-wheel steering, where the motor is embedded within the wheels of a vehicle, allowing each of the four wheels to be driven independently. These in-wheel motor systems can be organically combined into a vehicle to achieve four-wheel independent drive and four-wheel independent steering, providing more flexible and versatile driving performance.

Conventional vehicles equipped with four-wheel independent steering or rear-wheel steering are designed to determine a rear-wheel steering angle based on a front-wheel steering angle.

Determining the rear-wheel steering angle in this manner prevents more dynamic vehicle control and imposes limitations on utilizing the performance of rear-wheel steering.

In the past, steering angle speed or angular acceleration has been used. However, there are issues with the poor resolution of a steering angle sensor, and a delay arises from differentiating the steering angle two times to generate angular acceleration.

Furthermore, in a case where adjustments focus solely on a desired yaw rate, a significant and instantaneous reversal of gear ratios between the front and rear wheels at high speeds reduces turning radius but compromises driving stability.

Accordingly, there is a need for a method of improving driver convenience and driving stability by more dynamically controlling vehicles equipped with rear-wheel steering, in other words, by further adjusting the gear ratio between the front and rear wheels in response to column torque and vehicle speed, resulting in varying instantaneously the desired yaw rate or turning radius and enabling more dynamic lateral control than previously possible.

The related art of the present disclosure is disclosed in Korean Patent Registration No. 10-2274120 (registered on Jul. 1, 2021, and entitled “CONTROL APPARATUS AND METHOD FOR REAR WHEEL STEERING SYSTEM”).

### SUMMARY

Various embodiments, which are made to address the above-mentioned problem, are directed to an apparatus for and a method of controlling rear-wheel steering that improves driver convenience and driving stability by further adjusting a gear ratio between the front and rear wheels in response to column torque and vehicle speed, resulting in varying instantaneously a desired yaw rate or turning radius and enabling more dynamic lateral control than previously possible.

According to an aspect of the present disclosure, the apparatus for controlling rear-wheel steering includes: a sensor module configured to detect steering and driving information of a rear-wheel steering vehicle; and a processor configured to vary instantaneously a desired yaw rate or turning radius by further adjusting a gear ratio between the front and rear wheels in response to column torque and vehicle speed detected through the sensor module, resulting in more dynamic lateral control than previously possible.

In an embodiment, the processor may control a vehicle in an opposite-direction mode in low-speed sections lower than a specified speed.

In an embodiment, the processor may additionally control the rear wheels only when obstacle avoidance or sharp turns are required, while primarily steering in a same-direction mode in high-speed sections higher than or equal to a specified speed.

In an embodiment, the processor may vary the front and rear wheel angles based on changes in column torque, in which the column torque is applied to a differentiator, and the result is passed through a low pass filter (LPF) to eliminate noise.

In an embodiment, the processor may determine the rear-wheel angle proportional to the front-wheel angle based on the desired yaw rate, in which a closed-loop controller is applied to track a steady yaw rate based on the desired yaw rate that satisfies the conditions required to reach the steady yaw rate and control the front and rear wheels in the same or opposite direction according to vehicle speed.

In an embodiment, the processor may set a ratio for adjusting the front and rear wheel angles based on the change in column torque, applying a predetermined ratio table.

In an embodiment, the processor may adjust the front and rear wheel angles based on the ratio table, in which the angles dynamically increase as the ratio increases in response to an abrupt change in a driver's steering or a substantial increase in column torque.

In an embodiment, the processor may further compensate only the rear-wheel angle in the opposite-direction mode but compensate both the front and rear wheel angles in the same-direction mode according to the ratio table, when the wheel angles are additionally controlled based on the change in column torque.

In an embodiment, the processor may drive an ON/OFF control module that engages in ON/OFF control based on signals received from the front and rear wheels, as well as the ratio table, in which the ON/OFF control module switches between ON and OFF states, further compensating only the rear-wheel angle in the opposite-direction mode but compensating both the front and rear wheel angles in the same-direction mode, when the wheel angles are additionally controlled based on vehicle speed and the change in column torque.

According to another aspect of the present disclosure, the method of controlling rear-wheel steering includes: detecting steering and driving information of a rear-wheel steering vehicle through a sensor module; and varying instantaneously a desired yaw rate or turning radius by a processor further adjusting a gear ratio between the front and rear wheels in response to column torque and vehicle speed detected through the sensor module, resulting in more dynamic lateral control than previously possible.

According to the present disclosure, driver convenience and driving stability can be improved by further adjusting a gear ratio between the front and rear wheels in response to column torque and vehicle speed, resulting in varying instantaneously the desired yaw rate or turning radius and enabling more dynamic lateral control than previously possible.

According to the present disclosure, more dynamic vehicle control can be achieved as a vehicle is controlled while stably minimizing turning radius without responding to steering angle acceleration in low-speed sections, and the rear wheels are additionally controlled only when obstacle avoidance or sharp turns are required, while primarily steering in the same-direction mode to reduce slip angle and maintain a minimal yaw rate in high-speed sections.

According to the present disclosure, driving stability can be further improved by performing additional compensation control in the opposite-direction mode when the rear wheels turn in the opposite direction to the front wheels and performing additional compensation control in the same-direction mode when the rear wheels turn in the same direction as the front wheels.

### BRIEF DESCRIPTION OF THE DRAWINGS

FIG. 1 is an illustrative diagram showing a schematic configuration of 4-wheel independent steering including rear-wheel steering according to an embodiment of the present disclosure.

FIG. 2 is an illustrative diagram showing a configuration for a more specific description of lateral control in FIG. 1.

### DETAILED DESCRIPTION OF THE ILLUSTRATED EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

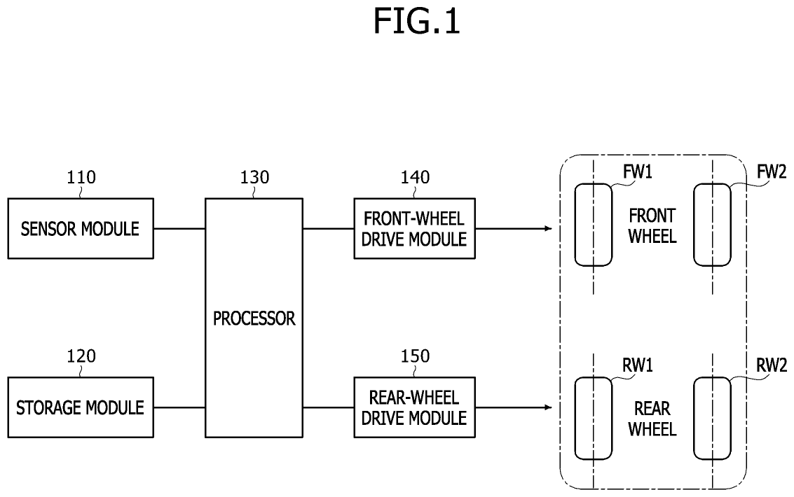

FIG. 1 is an illustrative diagram showing a schematic configuration of 4-wheel independent steering including rear-wheel steering according to an embodiment of the present disclosure.

As illustrated in FIG. 1, 4-wheel independent steering according to the embodiment of the present disclosure includes a sensor module 110, a storage module 120, a processor 130, a front-wheel drive module 140, and a rear-wheel drive module 150.

The sensor module 110 may include a current sensor (or a current detection sensor), a steering angle sensor (or a steering angle detection sensor), and a yaw rate sensor. The sensor module 110 may be referred to as a sensor.

The sensor module 110 may include wheel speed sensors, each incorporated in the front and rear wheels, and an acceleration sensor detecting vehicle acceleration.

The sensor module 110 may sense information related to the operation of vehicles, such as brakes.

The processor 130 may measure steering angle speed through a steering angle sensor.

The processor 130 may compute a driver's desired yaw rate using steering angles during steering maneuvers, driving directions, and vehicle speeds during which an accelerator pedal is pressed.

The storage module 120 may store an algorithm for the processor 130 to control the driving force of the rear wheel and store information (or data) detected through the sensor module 110. In this case, the storage module 120 and the processor 130 may be implemented as separate chips or may be implemented as a single chip configured to include the storage module 120 inside the processor 130. The processor 130 according to an exemplary embodiment of the present disclosure may be a hardware device implemented by various electronic circuits (e.g., computer, microprocessor, CPU, ASIC, circuitry, logic circuits, etc.). The processor 130 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor 130 may be implemented as separate semiconductor circuits. Alternatively, the memory and the processor 130 may be implemented as a single integrated semiconductor circuit. The processor 130 may embody one or more processor(s).

The storage module 120 may also be implemented as at least one of, but not limited to, a non-volatile memory device such as a cache, a read only memory (ROM), a programmable ROM (PROM), an erasable programmable ROM (EPROM), an electrically erasable programmable ROM (EEPROM), and a flash memory, or a volatile memory device such as a random access memory (RAM), or a storage medium such as a hard disk drive (HDD) or a CD-ROM.

In addition, the processor 130 may be implemented as an electronic control unit (ECU) that controls a vehicle while driving.

The front-wheel drive module 140 may be connected to the front wheels (FW1, FW2). Under the control of the processor 130, the front-wheel drive module 140 may drive actuators of the front wheels (FW1, FW2) (e.g., actuators adjusting the rotation direction, rotation speed, and steering angle of the front wheels by motors or hydraulics).

The front-wheel drive module 140 may be included in the processor 130.

The rear-wheel drive module 150 may be connected to the rear wheels (RW1, RW2). Under the control of the processor 130, the rear-wheel drive module 150 may drive actuators of the rear wheels (RW1, RW2) (e.g., actuators adjusting the rotation direction, rotation speed, and steering angle of the front wheels by motors or hydraulics).

The rear-wheel drive module 150 may be included in the processor 130.

In addition, the processor 130 may control both the front-wheel drive module 140 and the rear-wheel drive module 150, enabling the steering angles of the front and rear wheels to be either identical (i.e., same-direction control) or different (i.e., opposite-direction control).

The processor 130 may vary instantaneously the desired yaw rate or turning radius by further adjusting a gear ratio between the front and rear wheels in response to column torque and vehicle speed.

This may enable more dynamic lateral control than previously possible.

In low-speed sections, the processor 130 may control a vehicle while stably minimizing turning radius without responding to steering angle acceleration.

In high-speed sections, the processor 130 may additionally control the rear wheels only when obstacle avoidance or sharp turns are required, while primarily steering in the same-direction mode to reduce slip angle and maintain a minimal yaw rate.

This may enable more dynamic vehicle control than previously possible.

The processor 130 may perform additional compensation control in the opposite-direction mode when the rear wheels turn in the opposite direction to the front wheels and perform additional compensation control in the same-direction mode when the rear wheels turn in the same direction as the front wheels.

This may enable more improved driving stability than previously possible.

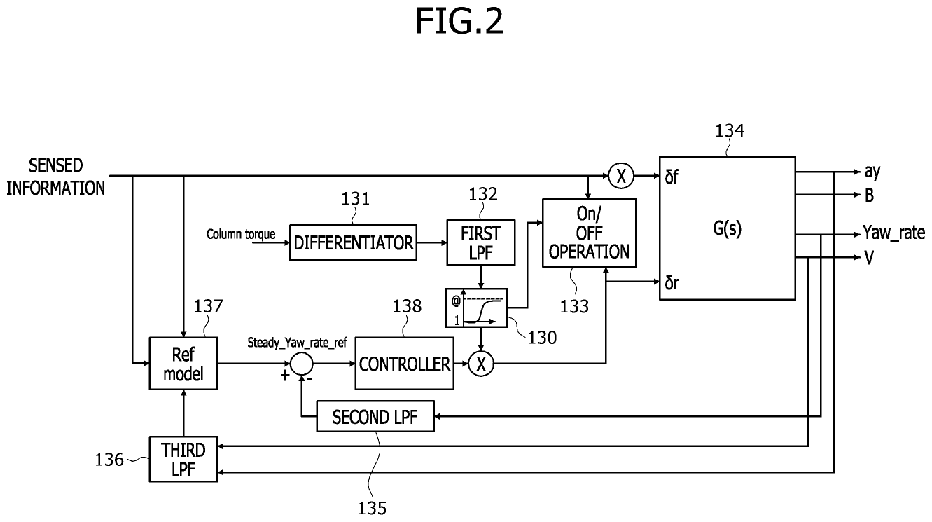

The control of rear-wheel steering by the processor 130 will be described with reference to FIG. 2 below.

FIG. 2 is an illustrative diagram showing a configuration for a more specific description of lateral control in FIG. 1. According to the present disclosure, rear-wheel steering control may enable more dynamic lateral control than previously possible.

With reference to FIG. 2, column torque may be applied to a differentiator 131 to be differentiated, and the result may be passed through a first low pass filter (LPF) 132 to eliminate noise.

Accordingly, the front and rear wheel angles (i.e., tire angles) may be variably adjusted based on changes in column torque.

Essentially, rear-wheel steering determines the rear-wheel angle proportional to the front-wheel angle based on a desired yaw rate.

In an embodiment of the present disclosure, a closed-loop controller may be applied to the processor 130 to track a steady yaw rate based on the desired yaw rate that satisfies the conditions required to reach the steady yaw rate and control the front and rear wheels in the same or opposite direction according to vehicle speed.

In the embodiment of the present disclosure, the front and rear wheel angles may be applied beyond a driver's steering range based on the change in column torque to instantaneously respond to a driver's steering (or steering intention), resulting in more dynamic lateral control than previously possible.

Note that the embodiment of the present disclosure may apply to vehicles, such as shift-by-wire (SBW) or 4-wheel steering (4WS) vehicles. These vehicles are configured to utilize a structure in which a rack bar is movably controlled by a motor (not shown) of an electric power steering, without the help of a steering force actuator-equipped column, relying solely on a wire.

In the embodiment of the present disclosure, a ratio for adjusting the wheel angle based on the change in column torque may be set by applying a predetermined ratio table 130 established through testing.

In this case, the ratio value is set to 1 when the change in column torque is at a minimum. Accordingly, the front and rear wheel angles may dynamically increase when the angles tracking the steady yaw rate (or steady-state yaw rate) are controlled, and the ratio increases in response to an abrupt change in a driver's steering or a substantial increase in column torque.

Under the conditions required to reach a steady yaw rate, when vehicle speed is higher than or equal to a specified speed (e.g., at high speeds), both the front and rear wheels are controlled in the same direction. However, when vehicle speed is lower than a specified speed (e.g., at low speeds), the front and rear wheels are controlled in the opposite direction. Importantly, when the wheel angles are additionally controlled based on the change in column torque, only the rear wheel angle is further compensated in the opposite-direction mode (i.e., at low speeds), while both the front and rear wheel angles are compensated in the same-direction mode (i.e., at high speeds).

Accordingly, an ON/OFF control module 133 engages in ON/OFF control based on signals received from the front and rear wheels, as well as the ratio table 130.

For example, the ON/OFF control module 133 switches between ON and OFF states, further compensating only the rear-wheel angle in the opposite-direction mode (i.e., at low speeds) but compensating both the front and rear wheel angles in the same-direction mode (i.e., at high speeds), when the wheel angles are additionally controlled based on vehicle speed and the change in column torque.

If an algorithm according to the embodiment of the present disclosure is not applied, indicating that the rear-wheel angle is controlled in the opposite direction instead of the same direction to track the desired yaw rate even at high speeds, or if only the rear wheel is further compensated in the same direction, it is difficult to execute a normal sharp turn. In addition, the maximum ratio is variably adjusted in real-time to be less than the maximum @ (i.e., the maximum limited angle for steering restrictions), taking into account the angle at which the wheel may mechanically turn.

For example, the front and rear wheel angles may be turned by approximately 30 to 40 degrees in normal driving conditions. Therefore, the maximum @ (i.e., the maximum limited angle for steering restrictions) is adjusted to prevent the wheel angle from turning beyond this limit. If a driver is turning with a wheel angle of 20 degrees and then instantaneously performs additional steering, the maximum @ is restricted to a specific limit (e.g., 2).

The final ratio value is determined by referencing the ratio table 130. For instance, if the ratio value is set to 1.2, the wheel angle may be adjusted to turn 20% more than the previous setting.

The embodiment of the present disclosure has described the rate table 130, the differentiator 131, the first LPF 132, and the ON/OFF control module 133 in FIG. 2. Given that the remaining components (134 to 138) primarily track steady yaw rate reference, only a brief description will be provided.

The steady yaw rate reference (or steady-state yaw rate ref), not explicitly detailed in the embodiment of the present disclosure, is determined as shown in Equation 1 below.

$$Steady\_state \_Yaw \_rate \_ref = ( \frac{1}{\frac{L}{V} + K \frac{V}{g}} ) δ f \qquad [ Equation 1 ]$$

Herein, K=Kᵤₛ indicates an understeer gradient value, V is vehicle speed, L is a wheelbase length of a vehicle, g is gravity acceleration, of is a front-wheel steering angle, and of is a rear-wheel steering angle.

In a reference model 137, vehicle speed (V) and lateral acceleration (ay), sensed in a vehicle, are fed back to a third LPF 136, which computes steady yaw rate reference. Due to severe noise in the yaw rate sensed in a vehicle, the sensed yaw rate is fed back to a second LPF 135 to compensate for the steady yaw rate reference, and the result is then applied to a controller 138.

Accordingly, the controller 138 engages in closed-loop control. In other words, the controller 138 adjusts the difference between the desired yaw rate and the feedback yaw rate to zero by minimizing errors to zero. In FIG. 2, B is a body slip angle.

Note that, the sensed yaw rate in dynamic 4-wheel steering (4WS), computed and fed back from the control model 134, is passed through the second LPF 135 (or a Kalman filter) to eliminate noise. Either an understeer gradient value (Kᵤₛ) or a variable gradient value (Kᵥₛ) is applied to accommodate a driver's steering preferences, such as steering angle speed or angular acceleration. This allows for the execution of oversteer, neutral steer, and understeer behaviors accordingly.

According to the present disclosure, as described above, driver convenience and driving stability can be improved by further adjusting a gear ratio between the front and rear wheels in response to column torque and vehicle speed, resulting in varying instantaneously the desired yaw rate or turning radius and enabling more dynamic lateral control than previously possible.

According to the present disclosure, more dynamic vehicle control can be achieved as a vehicle is controlled while stably minimizing turning radius without responding to steering angle acceleration in low-speed sections, and the rear wheels are additionally controlled only when obstacle avoidance or sharp turns are required, while primarily steering in the same-direction mode to reduce slip angle and maintain a minimal yaw rate in high-speed sections.

In addition, according to the present disclosure, driving stability can be further improved by performing additional compensation control in the opposite-direction mode when the rear wheels turn in the opposite direction to the front wheels and performing additional compensation control in the same direction mode when the rear wheels turn in the same direction as the front wheels.

What is claimed is:

1. An apparatus for controlling rear-wheel steering, comprising:
a sensor configured to detect steering and driving information of a rear-wheel steering vehicle; and
a processor configured to vary instantaneously a desired yaw rate or turning radius by further adjusting a gear ratio between front and rear wheels in response to column torque and vehicle speed detected through the sensor module, resulting in more dynamic lateral control than previously possible.

2. The apparatus of claim 1, wherein
the processor controls a vehicle in an opposite-direction mode in low-speed sections lower than a specified speed.

3. The apparatus of claim 1, wherein
the processor additionally controls the rear wheels only when obstacle avoidance or sharp turns are required, while primarily steering in a same-direction mode in high-speed sections higher than or equal to a specified speed.

4. The apparatus of claim 1, wherein
the processor varies front and rear wheel angles based on changes in the column torque,
wherein the column torque is applied to a differentiator, and a result is passed through a low pass filter (LPF) to eliminate noise.

5. The apparatus of claim 1, wherein
the processor determines a rear-wheel angle proportional to a front-wheel angle based on the desired yaw rate,
wherein a closed-loop controller is applied to track a steady yaw rate based on the desired yaw rate that satisfies conditions required to reach the steady yaw rate and control the front and rear wheels in the same or opposite direction according to vehicle speed.

6. The apparatus of claim 1, wherein
the processor sets a ratio for adjusting front and rear wheel angles based on changes in the column torque, applying a predetermined ratio table.

7. The apparatus of claim 6, wherein
the processor adjusts the front and rear wheel angles based on the ratio table,
wherein the front and rear wheel angles dynamically increase as the ratio increases in response to an abrupt change in a driver's steering or a substantial increase in the column torque.

8. The apparatus of claim 1, wherein
the processor further compensates only a rear-wheel angle in an opposite-direction mode but compensates both front and rear wheel angles in a same-direction mode according to a ratio table, when the wheel angles are additionally controlled based on changes in the column torque.

9. The apparatus of claim 8, wherein
the processor drives an ON/OFF control module that engages in ON/OFF control based on signals received from front and rear wheels, as well as the ratio table,
wherein the ON/OFF control module switches between ON and OFF states, further compensating only the rear-wheel angle in the opposite-direction mode but compensating both the front and rear wheel angles in the same-direction mode, when the wheel angles are additionally controlled based on vehicle speed and the change in the column torque.

10. A method of controlling rear-steering, the method comprising:
detecting steering and driving information of a rear-wheel steering vehicle through a sensor; and
varying instantaneously a desired yaw rate or turning radius by a processor further adjusting a gear ratio between front and rear wheels in response to column torque and vehicle speed detected through the sensor, resulting in more dynamic lateral control than previously possible.
